(19) United States
(12) Patent Application Publication
(10) Pub. No.: US 2025/0362905 A1
(43) Pub. Date: Nov. 27, 2025

(54) INFORMATION PROCESSING APPARATUS, METHOD, AND NON-TRANSITORY COMPUTER-READABLE MEDIUM

(71) Applicant: NEC Corporation, Tokyo (JP)

(72) Inventor: Takayuki KURODA, Tokyo (JP)

(73) Assignee: NEC Corporation, Tokyo (JP)

(21) Appl. No.: 19/203,388

(22) Filed: May 9, 2025

(30) Foreign Application Priority Data
May 24, 2024 (JP) 2024-084521

(51) Int. Cl. G06F 8/72

(52) U.S. Cl. CPC G06F 8/72

(57) ABSTRACT

An information processing apparatus comprises: at least one memory storing instructions; and at least one processor configured to execute the instructions to; extract, using a predetermined language model, a group of a plurality of code blocks including a similar description determined to have high similarity of feature information of a program by the language model from at least a part of a set of a plurality of programs included in predetermined software and generate, from the plurality of code blocks belonging to the group, using the language model, a common code block in which common processing based on the similar description is described and a plurality of partial code blocks corresponding to each code block based on a difference between each code block and the similar description.

### INCORPORATION BY REFERENCE

This application is based upon and claims the benefit of priority from Japanese patent application No. 2024-084521, filed on May 24, 2024, the disclosure of which is incorporated herein in its entirety by reference.

### TECHNICAL FIELD

The present disclosure relates to an information processing apparatus, a method, and a non-transitory computer-readable medium.

### BACKGROUND ART

Software refactoring is to organize and improve an internal structure without changing a function and a behavior of software. For example, a software engineer performs refactoring an amount of software by reducing duplicated codes or unifying code groups having the same roles (functions). JP 2015-179369 A discloses a technique for performing refactoring based on similarity of source codes included in software.

In recent years, a large language model (LLM) that is a type of artificial intelligence (AI) model has become widespread. The LLM is a trained model trained by repeating deep learning using a large data set for a natural language model.

### SUMMARY

Here, in a case where an attempt to apply a language model such as LLM to refactoring of large-scale software is made, there is a problem that it is difficult to obtain a sufficiently accurate refactoring result due to a limitation on a processing capability of the language model.

In view of the above-described problems, an example object of the present disclosure is to provide an information processing apparatus, a method, and a non-transitory computer-readable medium for supporting refactoring of large-scale software using a language model.

In a first example aspect, an information processing apparatus includes:
at least one memory storing instructions; and
at least one processor configured to execute the instructions to;
extract, using a predetermined language model, a group of a plurality of code blocks including a similar description determined to have high similarity of feature information of a program by the language model from at least a part of a set of a plurality of programs included in predetermined software and
generate, from the plurality of code blocks belonging to the group, using the language model, a common code block in which common processing based on the similar description is described and a plurality of partial code blocks corresponding to each code block based on a difference between each code block and the similar description.

In a second example aspect, an information processing method is an information processing method performed by an information processing apparatus which includes:
extracting, using a predetermined language model, a group of a plurality of code blocks including a similar description determined to have high similarity of feature information of a program by the language model from at least a part of a set of a plurality of programs included in predetermined software;
generating, from the plurality of code blocks belonging to the group, using the language model, a common code block in which common processing based on the similar description is described and a plurality of partial code blocks corresponding to each code block based on a difference between each code block and the similar description; and acquiring the common code block and the plurality of partial code blocks generated from the plurality of code blocks by the language model.

In a third example aspect. an information processing apparatus includes:
at least one memory storing instructions; and
at least one processor configured to execute the instructions to;
input, to the language model, an input text including an instruction sentence for extracting a similar description determined to have high similarity of feature information of a program by a predetermined language model from a plurality of code blocks included in a set of a plurality of programs included in predetermined software, and generating a common code block in which common processing based on the similar description is described and a plurality of partial code blocks corresponding to each code block based on a difference between each code block and the similar description, the input text including the plurality of code blocks; and
acquire the common code block and the plurality of partial code blocks generated from the plurality of code blocks based on the instruction sentence by the language model.

According to the present disclosure, it is possible to support large-scale software refactoring using a language model.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating an overall configuration of a refactoring support system including the information processing apparatus according to the present disclosure;

FIG. 4 is a block diagram illustrating a configuration of an information processing apparatus according to the present disclosure;

FIG. 5 is a flowchart illustrating a flow of a refactoring support method according to the present disclosure;

FIG. 6 is a diagram illustrating an example of a selected target source code group according to the present disclosure;

FIG. 7 is a diagram illustrating an example of a prompt input to an LLM according to the present disclosure;

FIG. 8 is a diagram illustrating an example of an output result from the LLM according to the present disclosure;

FIG. 9 is a diagram illustrating an example of an input target source code group according to the present disclosure;

FIG. 10 is a diagram illustrating an example of commonality of a common code block and a partial code block according to the present disclosure;

FIG. 11 is a diagram illustrating an example of an input target source code group according to the present disclosure;

FIG. 12 is a diagram illustrating an example of abstraction of a common code block and a partial code block according to the present disclosure;

FIG. 13 is a diagram for describing a concept of a refactoring support method according to the present disclosure;

FIG. 14 is a flowchart illustrating a flow of a refactoring support method according to the present disclosure;

FIG. 15 is a diagram illustrating an example of a grouping prompt input to an LLM according to the present disclosure;

FIG. 16 is a diagram illustrating an example of an output result (group of functions) from the LLM according to the present disclosure;

FIG. 17 is a diagram illustrating an example of a reconfiguration prompt input to the LLM according to the present disclosure;

FIG. 18 is a diagram illustrating an example of an output result (a common function and a subfunction group) from the LLM according to the present disclosure; and

FIG. 19 is a block diagram illustrating a hardware configuration of an information processing apparatus according to the present disclosure.

### EXAMPLE EMBODIMENT

Hereinafter, example embodiments of the present disclosure will be described in detail with reference to the drawings. In the drawings, the same or correspondent elements are denoted by the same reference numerals, and repeated description thereof will be omitted as necessary to clarify description.

### First Example Embodiment

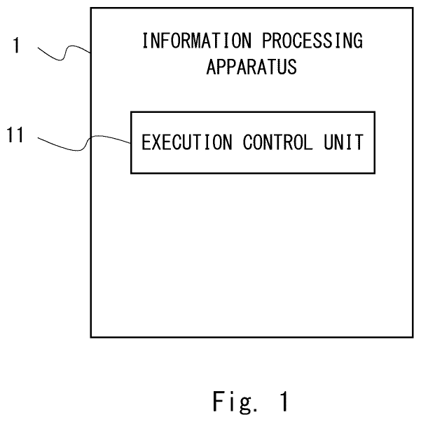

FIG. 1 is a block diagram illustrating a configuration of an information processing apparatus 1. The information processing apparatus 1 is a computer apparatus that supports refactoring of predetermined software using a predetermined language model. The information processing apparatus 1 may be referred to as a refactoring support apparatus.

Here, the “language model” is a computer program or an information system that receives, as an input, text data (input text) in which a question or an instruction is expressed in a natural language, and outputs text data subjected to processing such as generation, conversion, processing, and summarization by predetermined calculation on the input text. The language model corresponds to a natural language model in an AI model. In particular, the language model used by the information processing apparatus 1 according to the present disclosure is preferably an LLM. It is assumed that the language model is executed in the information processing apparatus 1, an external server connected to the information processing apparatus 1, or the like and can accept the input text.

The information processing apparatus 1 includes at least an execution control unit 11. The execution control unit 11 may be used as means for controlling execution of processing in accordance with a program in which the information processing method according to the present disclosure is implemented.

The execution control unit 11 extracts, using a predetermined language model, a group of a plurality of code blocks including a similar description determined to have highly similar feature information of a program by the language model from at least a part of a set of a plurality of programs included in predetermined software. The execution control unit 11 generates, from the plurality of code blocks belonging to a group, using the language model, a common code block in which common processing based on a similar description is described and a plurality of partial code blocks corresponding to each code block based on a difference between each code block and the similar description.

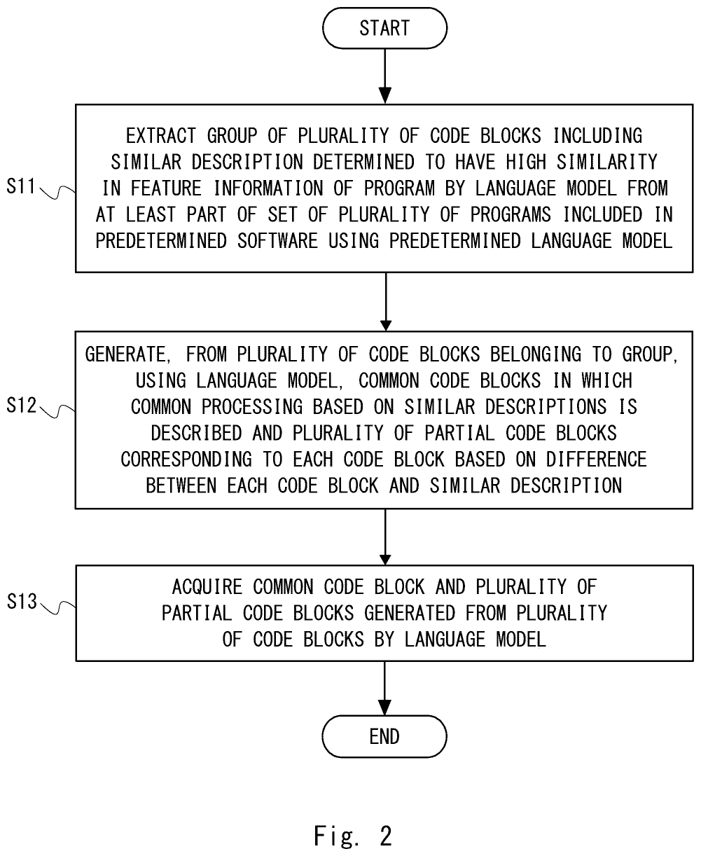

FIG. 2 is a flowchart illustrating a flow of an information processing method. First, using a predetermined language model, the information processing apparatus 1 extracts a group of a plurality of code blocks including a similar description determined to have high similarity of feature information of a program by the language model from at least a part of a set of a plurality of programs included in predetermined software (S11). Subsequently, the information processing apparatus 1 generates, from the plurality of code blocks belonging to the group, using the language model, common code blocks in which common processing based on similar descriptions is described and a plurality of partial code blocks corresponding to each code block based on a difference between each code block and the similar description (S12). Then, the information processing apparatus 1 acquires the common code block and the plurality of partial code blocks generated from the plurality of code blocks by the language model (S13).

Here, the common code block and the plurality of partial code blocks can be said to be a code block group refactored from a group of a plurality of code blocks including a similar description. Then, in a case where an attempt to acquire a code block group in which all of a set of a plurality of programs included in the predetermined software is refactored by a language model, there is a possibility that sufficient accuracy may not be obtained due to a limitation on a processing capability of the language model. On the other hand, the information processing apparatus 1 according to the present disclosure first extracts a group of a plurality of code blocks including a similar description from at least a part of the set of the plurality of programs included in the predetermined software using the language model. Accordingly, the group of code blocks that are refactoring processing target in a subsequent stage is narrowed down. Then, the information processing apparatus 1 inputs a group of code blocks narrowed down from the set of the plurality of programs to the language model and acquires a refactored code block group. Therefore, the acquired code block group can obtain a refactoring result with sufficient accuracy. Accordingly, the information processing apparatus 1 according to the present disclosure can support refactoring of large-scale software using a language model such as an LLM.

The information processing apparatus 1 includes a processor, a memory, and a storage device as a configuration (not illustrated). The storage device stores, for example, a computer program in which processing of an information processing method of FIG. 2 is implemented. The processor reads the computer program or the like from the storage device on the memory and executes the computer program. Accordingly, the processor realizes the function of the execution control unit 11.

Alternatively, each constituent of the information processing apparatus 1 may be realized by dedicated hardware. Some or all of the constituents of each apparatus may be realized by a general-purpose or dedicated circuitry, a processor, or a combination thereof. These constituents may be configured with a single chip or may be configured with a plurality of chips connected via a bus. Some or all of the constituents of each apparatus may be realized by a combination of the above circuitry or the like and a program. As the processor, a central processing unit (CPU), a graphics processing unit (GPU), a field-programmable gate array (FPGA), a quantum processor (quantum computer control chip), or the like can be used.

In a case where some or all of the constituents of the information processing apparatus 1 are realized by a plurality of information processing apparatuses, circuitry, or the like, the plurality of information processing apparatuses, circuitry, or the like may be centralized or distributed. For example, the information processing apparatus, the circuitry, and the like may be realized as a form of a system in which each of a client server system and a cloud computing system are connected via a communication network. The functions of the information processing apparatus 1 may be provided in software as a service (Saas) format.

### Second Example Embodiment

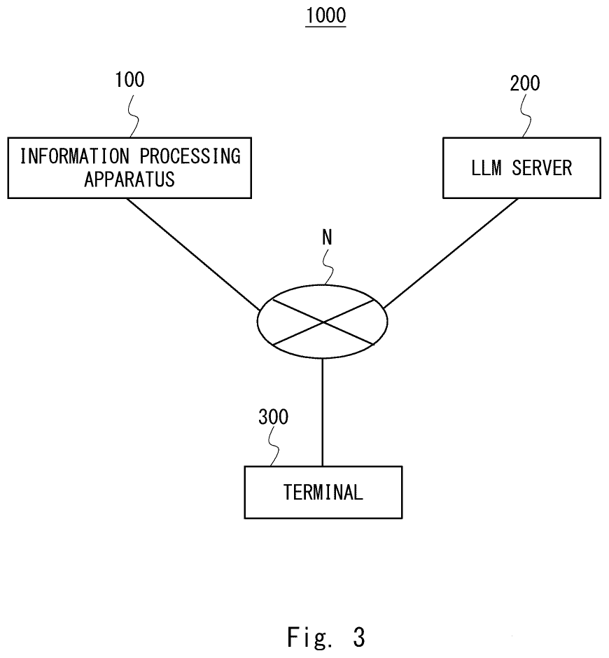

FIG. 3 is a block diagram illustrating an overall configuration of a refactoring support system 1000 including the information processing apparatus 100. The refactoring support system 1000 is an information system that supports refactoring of predetermined software using an LLM. The refactoring support system 1000 includes an information processing apparatus 100, an LLM server 200, and a terminal 300. The information processing apparatus 100, the LLM server 200, and the terminal 300 are each communicably connected via a network N. Here, the network N is a wired and/or wireless communication line network.

The terminal 300 is an information processing apparatus operated by a software engineer who develops, maintains, and modifies (in particular, refactors) software. The terminal 300 may be a general-purpose personal computer (PC) or the like. Therefore, the terminal 300 performs processing in response to an operation of a keyboard or a mouse by the engineer, and communicates with the information processing apparatus 100 via the network N as appropriate.

The LLM server 200 is a server computer on which a predetermined LLM operates. The LLM is an example of a language model in the above-described first example embodiment. The LLM is a trained model that is trained by repeating deep learning using a large data set on a predetermined natural language model. In the LLM, the number of times deep learning is executed, the number of data sets used for learning, and the number of parameters to be learned are larger than those at the time AI models started to spread. Therefore, the LLM may be referred to as a large-scale language model. The LLM is a computer program that accepts an input text (prompt) described in a specific format as an input, executes processing based on an instruction sentence included in the prompt, and outputs a processing result. Here, the prompt includes text data of a processing target and an instruction sentence in which processing on the text data is described in a specific format. In a case where an input text (prompt) is accepted from the request source via the network N, the LLM server 200 inputs the prompt to the LLM and returns output data that is a processing result obtained by the LLM to the request source via the network N. The request source is, for example, the information processing apparatus 100 or the terminal 300.

The information processing apparatus 100 is an example of the above-described information processing apparatus 1. The information processing apparatus 100 is a computer apparatus that generates a code block group obtained by refactoring at least a part of a set of a plurality of programs included in predetermined software using an LLM. Specifically, the information processing apparatus 100 receives an instruction to refactor target software from the terminal 300 via the network N. Then, the information processing apparatus 100 selects a group of target source codes from the part of the set of the plurality of programs included in the target software and generates a common code block and a plurality of partial code blocks from a source code group belonging to the group. At this time, the information processing apparatus 100 communicates with the LLM server 200 to generate the common code block and the plurality of partial code blocks. The information processing apparatus 100 generates the common code block and the plurality of partial code blocks a plurality of times by repeating communication with the LLM server 200.

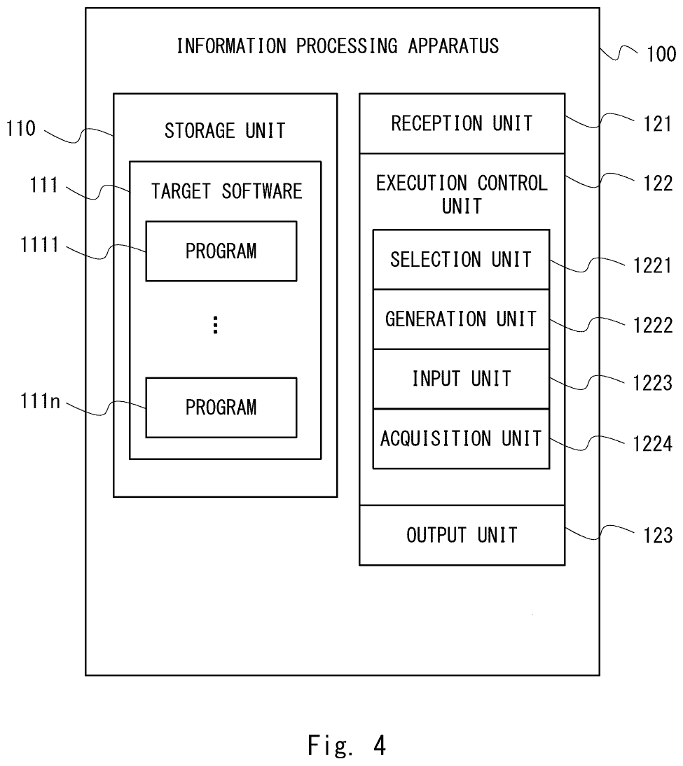

FIG. 4 is a block diagram illustrating a configuration of the information processing apparatus 100. The information processing apparatus 100 includes a storage unit 110, a reception unit 121, an execution control unit 122, and an output unit 123. The reception unit 121, the execution control unit 122, and the output unit 123 may be used as means for receiving information or data, means for controlling execution, and means for outputting information or data, respectively. The execution control unit 122 includes a selection unit 1221, a generation unit 1222, an input unit 1223, and an acquisition unit 1224. The selection unit 1221, the generation unit 1222, the input unit 1223, and the acquisition unit 1224 may be used as means for selecting information or data, means for generating information or data, means for inputting information or data, and means for acquiring information or data, respectively.

The storage unit 110 includes, for example, a nonvolatile storage device such as a flash memory and a memory such as a random access memory (RAM), that is, a volatile storage device. The storage unit 110 stores target software 111. The target software 111 may be stored in a storage device outside of the information processing apparatus 100. The target software 111 is an example of software that is refactoring target. The target software 111 includes a program 1111, . . . , and a program 111n (where n is a natural number of 2 or more).

The reception unit 121 receives an instruction to refactor the target software from the terminal 300 via the network N. The instruction may include, for example, identification information or the like of the target software 111. Alternatively, in a case where the target software is stored in an external storage device, the instruction includes access information to a storage device that is a storage destination of the target software. In this case, the reception unit 121 may receive the source code of each program by appropriately reading a part or all of a set of a plurality of programs included in the target software from the storage device via the network N using the access information included in the instruction.

The reception unit 121 may receive a prompt to be described below from the terminal 300. The reception unit 121 may receive an instruction regarding whether to continue refactoring from the terminal 300.

The execution control unit 122 is an example of the above-described execution control unit 11. Specifically, the execution control unit 122 includes functions of the selection unit 1221, the generation unit 1222, the input unit 1223, and the acquisition unit 1224.

The selection unit 1221 selects a target source code group in one refactoring process among the target software. For example, the selection unit 1221 may select a set of arbitrary programs from a plurality of programs 1111 and the like included in the target software 111 and may use the set as the target source code group.

Alternatively, the selection unit 1221 may select any partial block (fragment) of the source code from among some of the plurality of programs 1111 and the like as the target source code group. Alternatively, the selection unit 1221 may receive, from the terminal 300, a selection of the target source code group in one refactoring process among the target software. Each of the selected target source code groups is assumed to be a processing unit of some functional blocks.

Alternatively, the selection unit 1221 may select the group as a target source code group by extracting a group of a plurality of code blocks including a similar description in which similarity of the feature information of the program is equal to or greater than a threshold from the plurality of programs 1111 or the like using the program in which the predetermined processing logic is implemented. For example, the selection unit 1221 analyzes each of the plurality of programs 1111 or the like to generate feature information of each program. The selection unit 1221 then detects a similar description in which similarity of the feature information is equal to or greater than the threshold between the programs. The selection unit 1221 may group programs including the detected similar description and select the programs as the target source code group.

The similar description of the program is preferably a code block in which processing of the program is semantically similar. The feature information of the program may include a logical structure of the program. That is, the feature information of the program indicates not only a feature of a character string level of a written code or syntax but also a feature of a function level of the program. Therefore, the similar description refers to a description that is equivalent in a functional level of the program despite a difference in a level of a character string or a syntax of the described code between the plurality of source codes. The term “equivalent in the functional level of the program” means that, for example, even though there is a difference such as a for sentence or a while sentence or a difference such as an if sentence or a switch-case sentence between first and second source codes, there is similarity in logical structures.

The generation unit 1222 generates a prompt that is an input text to an LLM of the LLM server 200. Specifically, the generation unit 1222 generates, as a prompt, an input text including an instruction sentence for generating the common code block and the plurality of partial code blocks and the target source code group (the plurality of code blocks) selected by the selection unit 1221.

Here, the common code block is a code block in which common processing based on the similar description included in the selected target source code group is described. The “common processing based on a similar description” is processing based on a common description among similar descriptions among a plurality of code blocks. Therefore, similar descriptions are not necessarily common descriptions among the plurality of code blocks. For example, in a case where each of the similar descriptions among the plurality of code blocks has similarity in the logical structure despite a difference in a syntax level, processing by a predetermined syntax having commonality in the logical structure may be set as common processing.

The plurality of partial code blocks is a group of partial code blocks corresponding to each code block based on a difference between each code block and a similar description. That is, the instruction sentence is a sentence for causing an LLM to generate, from a plurality of code blocks belonging to a group, a common code block in which common processing based on a similar description is described and a plurality of partial code blocks corresponding to each code block based on a difference between each code block and the similar description.

The input unit 1223 inputs the prompt generated by the generation unit 1222 to the LLM. Specifically, the input unit 1223 inputs the prompt to the LLM by transmitting the prompt to the LLM server 200 via the network N.

The acquisition unit 1224 acquires the common code block and the plurality of partial code blocks generated by the LLM in response to the prompt as output data. That is, the acquisition unit 1224 acquires the common code block and the plurality of partial code blocks generated from the plurality of code blocks based on the instruction sentence by the LLM.

From the above, it can be said that the execution control unit 122 causes the LLM to generate the common code block and the plurality of partial code blocks so that each of the plurality of partial code blocks has the same function as each corresponding code block using the common code block.

The selection unit 1221 may use LLM to group the programs including the similar description in which the LLM determines that similarity of the feature information of the program is high among the plurality of programs 1111 or the like, and may select the programs as the target source code group. In this case, the generation unit 1222 may generate an instruction sentence for extracting a group of a plurality of code blocks including a similar description from at least a part of the plurality of programs 1111 or the like. The generation unit 1222 may generate an input text including the generated instruction sentence and at least some of the plurality of programs 1111 or the like as a grouping prompt. Then, the input unit 1223 inputs the grouping prompt to the LLM. The acquisition unit 1224 acquires the common code block and the plurality of partial code blocks generated by the LLM in accordance with the grouping prompt as output data.

Further, the execution control unit 122 may set the common code block and the plurality of partial code blocks generated by the LLM as targets together with programs other than the group among a set of the plurality of programs, and may repeatedly execute the extraction of the group and the generation of the common code block and the plurality of partial code blocks using a language model. As described above, by repeating local organization of programs (commonality and separation of similar processing), it is possible to support reconfiguration for organizing software stepwise using the LLM and performing overall optimization.

The generation unit 1222 may generate an instruction sentence for extracting the group of the plurality of code blocks including the similar description from at least the part of the set of the plurality of programs and generating, from the plurality of code blocks belonging to the group, the common code block in which common processing based on the similar description is described and the plurality of partial code blocks corresponding to each code block based on the difference between each code block and the similar description. The input unit 1223 may input the input text including the generated instruction sentence and at least the part of the set of the plurality of programs to the LLM.

The output unit 123 outputs the output data acquired by the acquisition unit 1224. For example, the output unit 125 may display output data on a display device contained in or connected to the information processing apparatus 1. Specifically, the output unit 125 may cause the terminal 300 to display the output data by transmitting the output data to the terminal 300 via the network N.

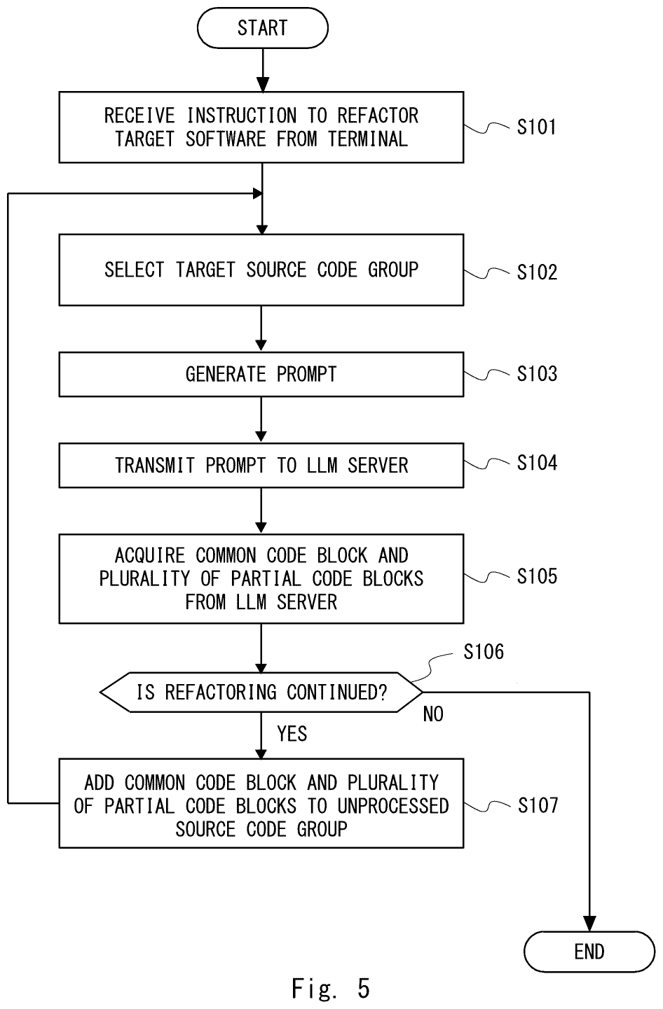

(Example 1 of Use Case of Refactoring Support Processing) FIG. 5 is a flowchart illustrating a flow of a refactoring support method. First, an engineer inputs an instruction to refactor the predetermined software to the terminal 300. Then, the terminal 300 transmits an input instruction to the information processing apparatus 100 via the network N in response to the operation of the engineer.

In response to this, the reception unit 121 receives an instruction to refactor the target software from the terminal (S101). In the following description, it is assumed that the target software 111 is designated in the instruction.

Subsequently, the selection unit 1221 selects a target source code group from the target software 111 (S102). Here, the selection unit 1221 selects a pair of source codes (two code blocks) as the target source code group in accordance with any of the above-described various methods. Accordingly, it is possible to narrow down a processing target source code group per process of the LLM and reduce a processing load of the LLM.

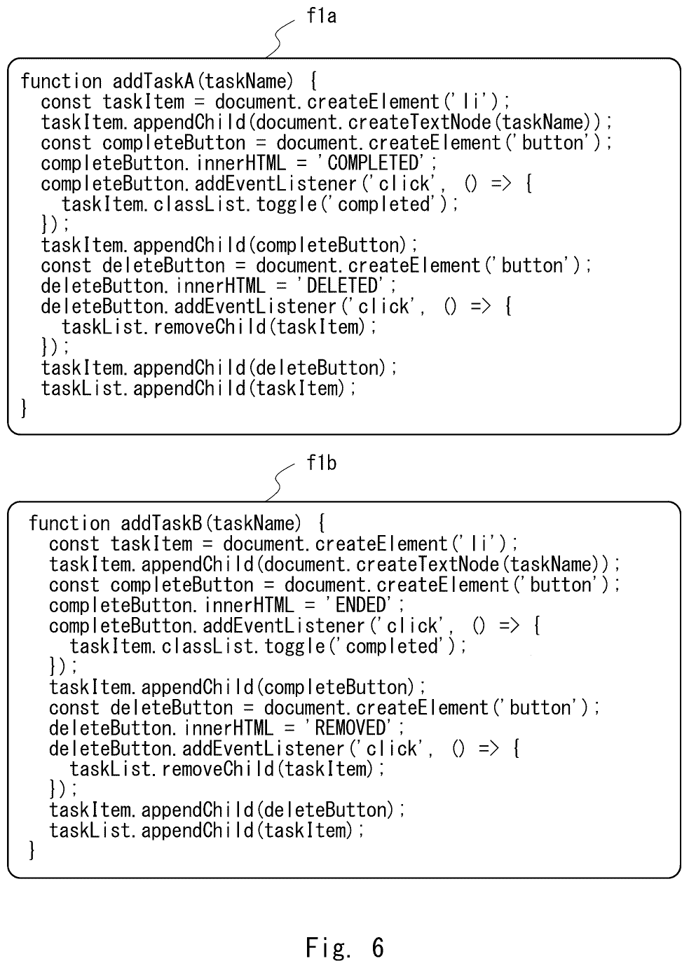

FIG. 6 is a diagram illustrating examples of functions f1a and f1b which are selected target source code groups. The function f1a corresponds to a code block (source code) indicating a function “addTaskA”. The function f1b corresponds to a code block (source code) indicating a function “addTaskB”. The functions f1a and f1b indicate that descriptions of the function names “addTaskA” and “addTaskB” in the first line, substituted values “completed” and “ended” in the fifth line, and substituted values “deleted” and “removed” in the eleventh line are different. That is, the code blocks of the functions f1a and f1b are both seventeen lines, and the difference is three lines. In other words, the functions f1a and f1b indicate that some of first, fifth, and eleventh lines are similar to the other lines. In a case where a feature amount of the program is a description (character string) for each line of codes, similarity between the feature amounts of the programs of the functions f1a and f1b is about 82%. In a case where a threshold of the similar description is assumed to be 70%, the functions f1a and f1b can be said to be a set of code blocks including the similar description. Even in a case where the feature amount of the program is a logical structure and the threshold of the similar description is 70%, the functions f1a and f1b can be said to be a set of code blocks including the similar description. In the following description, it is assumed that two functions “addTaskA” and “addTaskB” are selected as the target source code group.

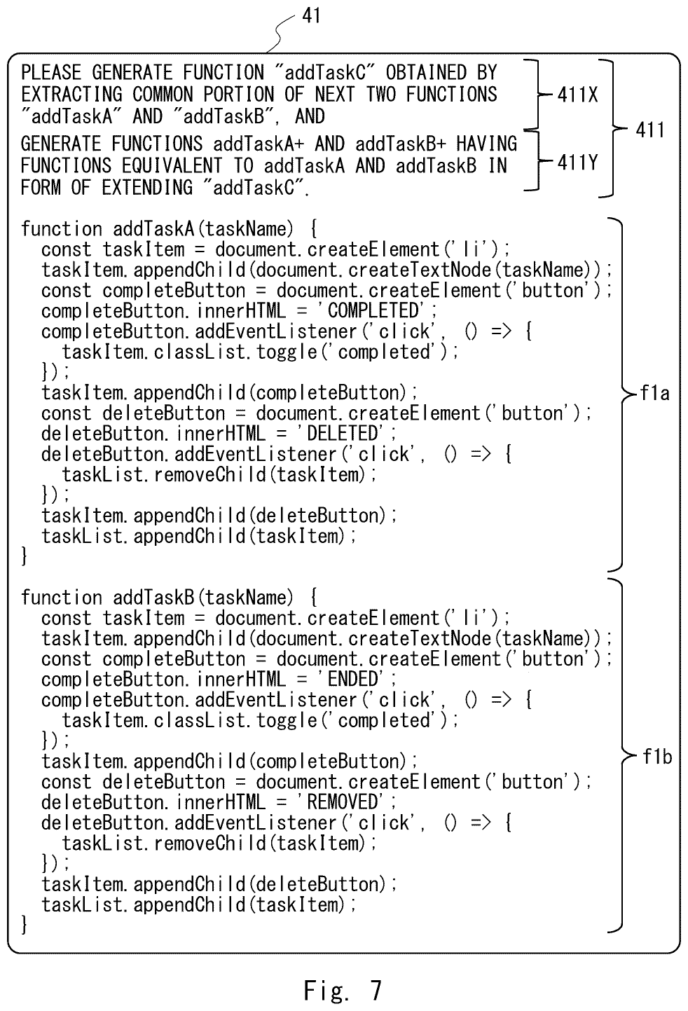

Subsequently, the generation unit 1222 generates a prompt for generating the common code block and the plurality of partial code blocks from the selected target source code group (S103). FIG. 7 is a diagram illustrating an example of a prompt 41 input to LLM. The prompt 41 is an example of text data (input text) including an instruction sentence 411 and the target source code group (functions f1a and f1b). The instruction sentence 411 includes instruction sentences 411X and 411Y. The instruction sentence 411X is a sentence for generating a common function “addTaskC” obtained by extracting a common portion of the two functions f1a and f1b. The instruction sentence 411Y is a sentence for generating two functions having functions equivalent to the functions f1a and f1b in a form of extending the common function “addTaskC”.

Subsequently, the input unit 1223 transmits the prompt 41 to the LLM server 200 (S104). Accordingly, the LLM server 200 inputs the received prompt 41 to the LLM. The LLM extracts the common processing based on the similar processing from the functions f1a and f1b in accordance with the instruction sentence 411X of the instruction sentence 411 included in the prompt 41, and generates the common function “addTaskC” in which the common processing is described. Then, the LLM generates functions “addTaskAPlus” and “addTaskBPlus” having functions equivalent to the functions f1a and f1b in a form of extending the common function in accordance with the instruction sentence 411Y of the instruction sentence 411 included in the prompt 41. That is, the LLM generates the common code block and the plurality of partial code blocks based on the instruction sentences 411X and 411Y so that each of the plurality of partial code blocks has the same function as each corresponding code block using the common code block. The LLM server 200 transmits an output message including the common code block and the plurality of partial code blocks generated by LLM to the information processing apparatus 100 via the network N.

Accordingly, the acquisition unit 1224 acquires an output message including the common code block and the plurality of partial code blocks from the LLM server 200 (S105). Then, the output unit 123 displays the output message on the developer terminal 300. Specifically, the output unit 123 transmits the acquired output message to the developer terminal 300 via the network N. Then, the developer terminal 300 displays the received output message on the screen.

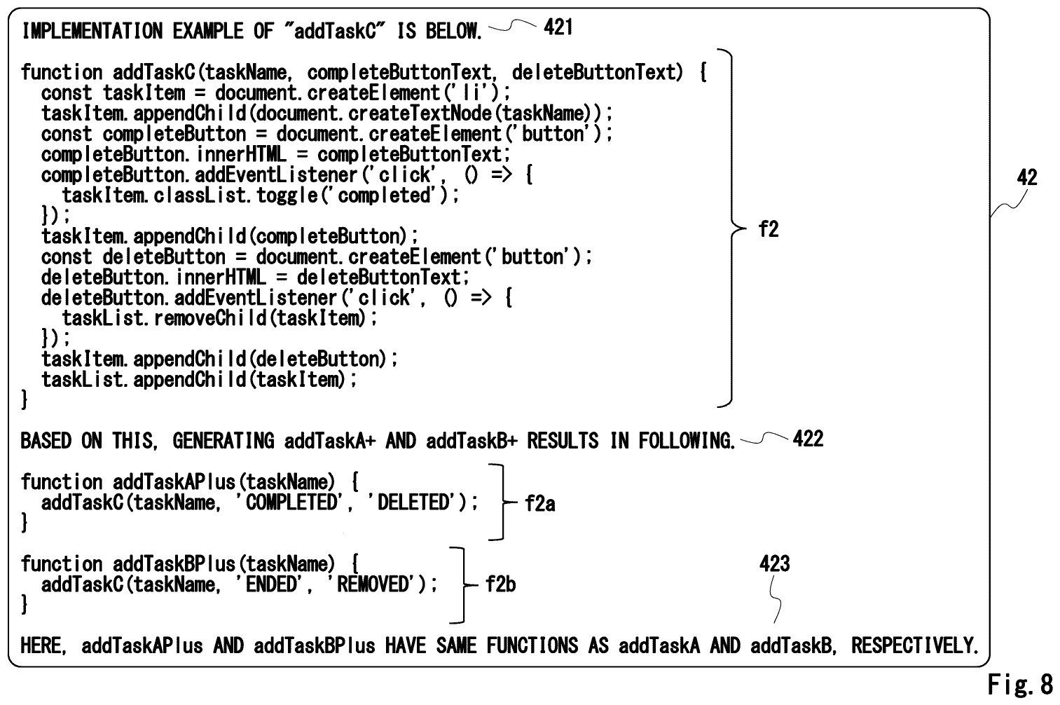

FIG. 8 is a diagram illustrating an example of an output result from the LLM. An output data 42 is an example of an output message 421, a common code block f2, an output message 422, partial code blocks f2a and f2b, and an output message 423 displayed on the screen of the terminal 300. The output message 421 is text data added by the LLM during the common code block f2 is generated. The common code block f2 is an example of a common function “addTaskC”. The common function “addTaskC” is a function in which the common processing extracted from the functions f1a and f1b is implemented. Specifically, the common function “addTaskC” is a code block in which a function name and arguments in the first line of the functions f1a and f1b are corrected, a substituted value in the fifth line is corrected to “completeButtonText”, and a substituted value in the eleventh line is corrected to “deleteButtonText”. The output messages 422 and 423 are text data added by the LLM during the plurality of partial code blocks are generated. The partial code block f2a is a code block in which the similar description from the function f1a is excluded, the function name in the first line is corrected, and the common function “addTaskC” is called in the second line, and two substituted values (character strings) of a difference from the function f1b are set to the arguments. The partial code block f2b is a code block in which the similar description from the function f1b is excluded, the function name in the first line is corrected, and the common function “addTaskC” is called in the second line, and two substituted values (character strings) of a difference from the function f1a are set to the arguments. Therefore, in the example of FIG. 8, it can be said that the common code block is a function of a program, and each of the plurality of partial code blocks is generated including processing for calling the common code block.

Then, the execution control unit 122 determines whether to continue the refactoring (S106). For example, it is assumed that the engineer checks the output data 42 of FIG. 8 through the terminal 300 and wants to continue the refactoring, including other code blocks and other common code blocks that have already been refactored. In this case, the terminal 300 transmits an instruction to continue the refactoring via the network N in response to an operation of the engineer. Then, the reception unit 121 receives the instruction to continue the refactoring from the terminal 300. In this case, the execution control unit 122 determines to continue the refactoring. Alternatively, the execution control unit 122 may determine to continue the refactoring in a case where the number of times the refactoring support processing is repeated (steps S102 to S105) is less than a threshold. Alternatively, in a case where there is an unprocessed source code group other than the target source code group selected in step S102 in the program set of the target software, the execution control unit 122 may determine to continue the refactoring.

In a case where it is determined in step S106 that the refactoring is continued, the execution control unit 122 adds the common code block and the plurality of partial code blocks acquired in step S105 to the unprocessed source code group (S107). Thereafter, the information processing apparatus 100 executes steps S102 to S106 in the same manner as described above. Therefore, the selection unit 1221 may select a pair or a set of common code blocks as the target source code group in step S102. In this case, for example, the common functions can be further expanded (commonalized). Alternatively, the selection unit 1221 may select a pair or a set of an unprocessed code block and a common code block in step S102 as the target source code group. In this case, the unprocessed code block (function) may be corrected to a partial code block so that the common function that has already been commonalized is called. Therefore, local organization of programs (commonality and separation of similar processing) can be repeated.

Conversely, in a case where the reception unit 121 receives an instruction not to continue the refactoring from the terminal 300, the execution control unit 122 determines not to continue the refactoring. Alternatively, the execution control unit 122 may determine not to continue the refactoring in a case where the number of times the refactoring support processing is repeated is equal to or greater than a threshold. Alternatively, in a case where there is no unprocessed source code group in the program set of the target software, the execution control unit 122 may determine not to continue the refactoring. In a case where it is determined in step S106 that the refactoring is not continued, the information processing apparatus 100 ends the refactoring support processing.

### Example 2 of Use Case of Refactoring Support Processing

For example, it is assumed that a software engineer of a certain company maintains and modifies a web application developed 10 years ago or more. Various functions such as user authentication, access to a database (DB), processing for calling an external application programming interface (API), and product searching are implemented in the web application. Then, it is assumed that the web application has complicated codes due to long-time function addition and modification, and maintainability deteriorates. Accordingly, the engineer aims at improving a structure of codes and improving maintainability by refactoring the web application using the refactoring support system 1000 according to the present disclosure.

Hereinafter, in FIG. 5, differences from FIGS. 6 to 8 will be mainly described, and repeated description thereof will be omitted as appropriate. Here, it is assumed that the engineer designates three functions login, logout, changePassword in the web application of the target software as a target source code group. Therefore, the reception unit 121 accepts a selection of the above three functions together with an instruction to refactor the target web application from the terminal (S101). Therefore, in step S102 of FIG. 5, the selection unit 1221 selects the above three functions as the target source code group (S102). Then, the generation unit 1222 generates a prompt for generating the common code block and the plurality of partial code blocks from the selected three functions (S103).

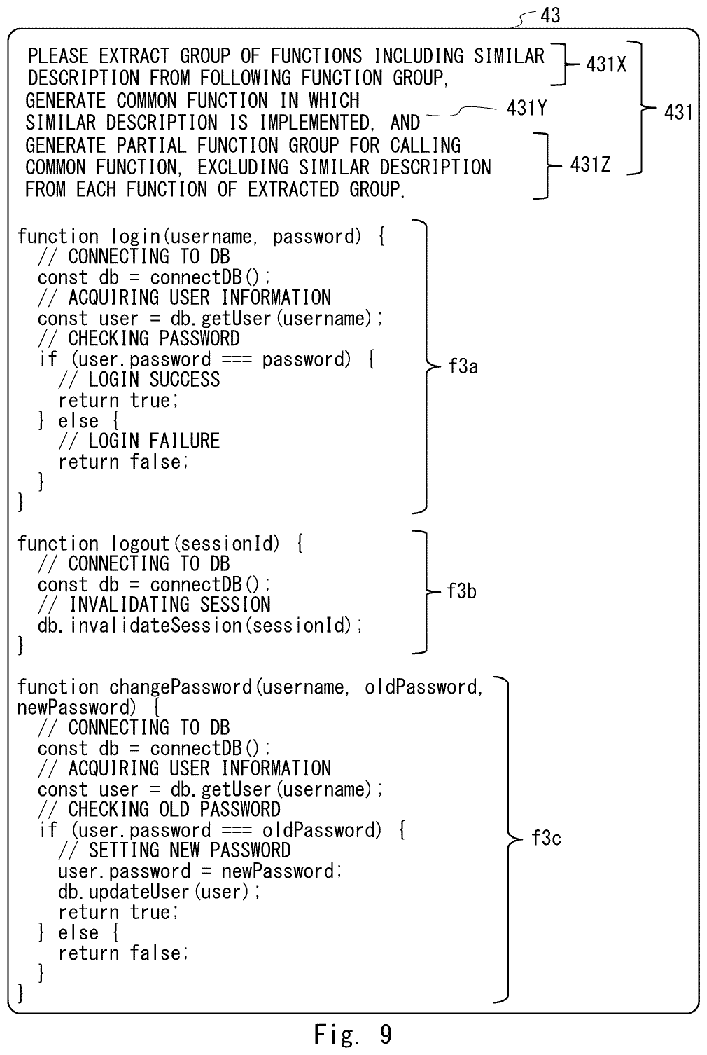

FIG. 9 is a diagram illustrating an example of an input target source code group. The prompt 43 is an example of text data (input text) including an instruction sentence 431 and the target source code group (functions f3a, f3b and f3c). The instruction sentence 431 includes instruction sentences 431X, 431Y, and 431Z. The instruction sentence 431X is a sentence for extracting a group of functions including the similar description from the three functions f3a, f3b, and f3c. The instruction sentence 431Y is a sentence for generating the common function in which the similar description of the function belonging to the extracted group is implemented. The instruction sentence 431Z is a sentence for generating a partial function group for calling the common function, excluding the similar description from each function of the extracted group.

Subsequently, the input unit 1223 transmits the prompt 43 to the LLM server 200 (S104). Accordingly, the LLM server 200 inputs the received prompt 43 to the LLM. The LLM extracts a group of functions including the similar description from the three functions in accordance with the instruction sentence 431X of the instruction sentence 431 included in the prompt 43. In the example of FIG. 9, the functions f3a “login”, f3b “logout”, and f3c “changePassword” include DB connection processing. The functions f3a “login” and f3c “changePassword” include user information acquisition processing. Therefore, since the LLM includes two types of similar processing, that is, DB connection processing and the user information acquisition processing for the functions f3a and f3c among the three functions, the LLM extracts the functions f3a and f3c as a group of functions including the similar description in which similarity of the feature information of the program is equal to or greater than a threshold.

Then, the LLM extracts the common processing (the DB connection processing and the user information acquisition processing) based on the similar processing from the functions f3a and f3c belonging to the extracted group in accordance with the instruction sentence 431Y of the instruction sentence 431 included in the prompt 43, and generates the common function “connectAndGetUser” in which the common processing is described. Then, the LLM generates a partial function group for calling the common function, excluding the similar description from each function of the extracted group in accordance with the instruction sentence 431Z of the instruction sentence 431 included in the prompt 41. The LLM server 200 transmits an output message including the common code block and the plurality of partial code blocks generated by LLM to the information processing apparatus 100 via the network N.

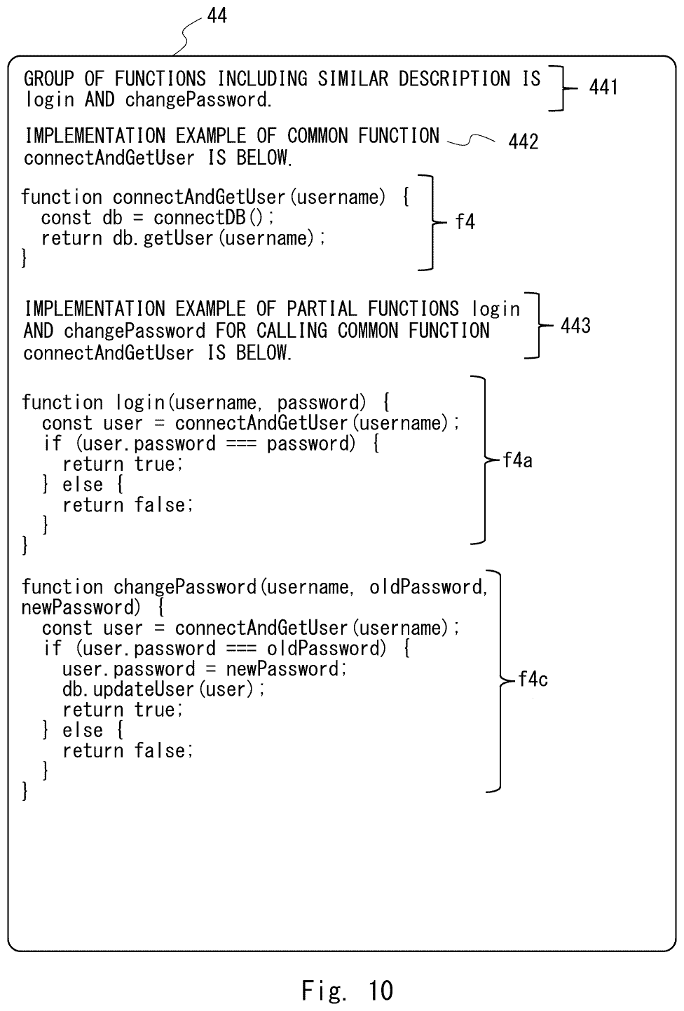

FIG. 10 is a diagram illustrating an example of commonality of a common code block and a partial code block. The output data 44 is an example of the output messages 441 and 442, the common code block f4, the output message 443, and the partial code blocks f4a and f4c displayed on a screen of the terminal 300. The output message 441 is text data added by the LLM during a group of functions including the similar description is extracted. This example indicates that the functions f3a “login” and f3c “changePassword” are extracted as a group.

The output message 442 is text data added by the LLM during the common code block f4 is generated. The common code block f4 is an example of the common function “connectAndGetUser”. The common function “connectAndGetUser” is a function in which the common processing extracted from the functions f3a and f3c is implemented. Specifically, the common function is a function in which the user name is used as an argument and a result of the user information acquisition processing is used as a return value using the user name as an argument after the DB connection processing.

The output message 443 is text data added by the LLM during the plurality of partial code blocks are generated. Each of the partial code blocks f4a and f4c is a block for changing the DB connection processing and the user information acquisition processing from each of the functions f3a and f3c to a description for calling the common function “connectAndGetUser”.

As described above, in Example 2 of the use case, three functions selected by the engineer are set as refactoring targets, a pair of two functions are grouped as commonality targets by the LLM, and the common function and two partial functions are generated for the pair of two grouped functions. Therefore, the entire source code of the target web application is not input, and the engineer narrows down the target source code to some extent. Then, the LLM narrows down the three functions targeted by the prompt to two function groups of commonality targets, and performs refactoring of commonality and separation (calling of the common function) on the narrowed function group. Therefore, it is possible to obtain a sufficiently accurate refactoring result in consideration of a restriction of the processing capability of the LLM.

For example, a plurality of functions (login, password change, and the like) related to user authentication are grouped. Subsequently, the common processing (the DB connection processing and the user information acquisition processing) is extracted from the grouped functions, and a function group including a function responsible for the common processing and a portion unique to each processing is generated. Similarly, the common processing is also extracted from the function group related to the product searching. Then, by applying the refactoring processes to the entire source code of the target software step by step, an authentication module, a product searching module, and the like can be finally generated. These modules can be said to be modules reconfigured into an easy-to-understand structure separated from other functions. A set of the reconfigured common code block and the plurality of partial code blocks has a more modular structure while having the same function as the original plurality of code blocks. Accordingly, the target software (source code) is reconfigured into a structure that is easier to understand and has high maintainability. As described above, according to the present disclosure, it is possible to automatically organize large-scale software and improve quality and maintainability by utilizing a language understanding ability of the LLM. Further, the present disclosure can also be applied to an improvement in productivity in a software development site, an improvement in legacy code, and the like.

(Example 3 of Use Case of Refactoring Support Processing) Next, an example in which, in refactoring, a superclass in which a plurality of classes are abstracted is generated based on object orientation, and modified (generated) from each class as a subclass group of the superclass will be described.

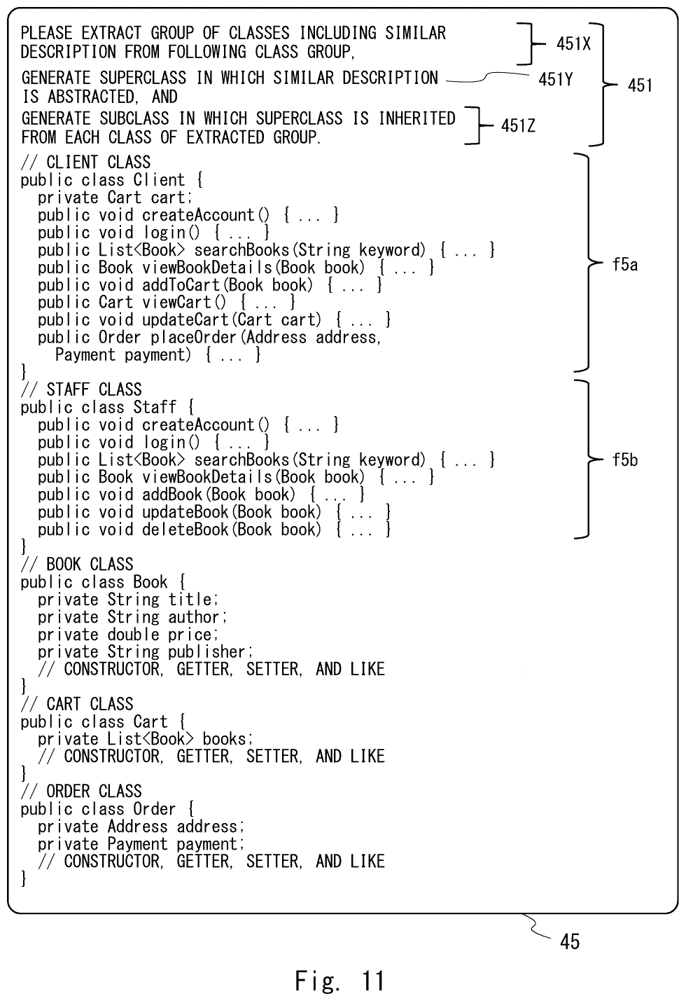

FIG. 11 is a diagram illustrating an example of an input target source code group. A prompt 45 is an example of text data (input text) including an instruction sentence 451 and the target source code group (classes f5a and f5b). The instruction sentence 451 includes instruction sentences 451X, 451Y, and 451Z. The instruction sentence 451X is a sentence for extracting a group of classes including a similar description from the plurality of classes f5a and f5b. The instruction sentence 451Y is a sentence for generating a superclass in which the similar description of the class belonging to the extracted group is abstracted. The instruction sentence 451Z is a sentence for generating a subclass in which the superclass is inherited from each class of the extracted group.

Subsequently, the input unit 1223 transmits the prompt 45 to the LLM server 200 (S104). Accordingly, LLM server 200 inputs the received prompt 45 to the LLM. The LLM extracts a group of classes including a similar description from the classes f5a and f5b and the like in accordance with the instruction sentence 451X of the instruction sentence 451 included in the prompt 45. In the example of FIG. 11, methods “createAccount”, “login”, “searchBooks”, and “viewBookDetails” can be said to be duplicated descriptions in the classes f5a “Client” and f5b “Staff”. In a case where a threshold of the number of duplicated methods is 1, the classes f5a and f5b have the threshold or more and include the similar description since the number of duplicated methods is 5. Accordingly, the LLM extracts the classes f5a and f5b as a group.

Then, the LLM extracts the common processing based on the similar processing from the classes f5a and f5b belonging to the extracted group in accordance with the instruction sentence 451Y of the instruction sentence 451 included in the prompt 45 and generates the superclass “User” obtained by abstracting the classes f5a and f5b. Then, the LLM excludes the similar description from each class of the extracted group in accordance with the instruction sentence 451Z of the instruction sentence 451 included in the prompt 45 and generates a subclass group that inherits the superclass. The LLM server 200 transmits an output message including the common code block and the plurality of partial code blocks generated by LLM to the information processing apparatus 100 via the network N.

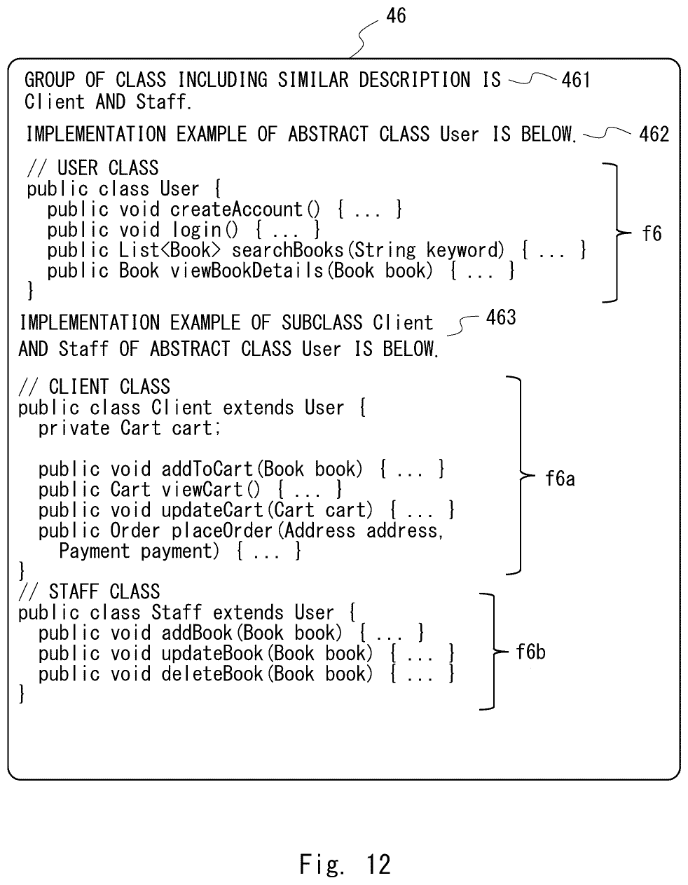

FIG. 12 is a diagram illustrating an example of abstraction of a common code block and a partial code block. The output data 46 is an example of output messages 461 and 462, the common code block f6, an output message 463, and the partial code blocks f6a and f6b displayed on the screen of the terminal 300. The output message 461 is text data added by the LLM during a group of classes including similar descriptions is extracted. This example indicates that the classes f5a “Client” and f5b “Staff” are extracted as a group.

The output message 462 is text data added by the LLM during the common code block f6 is generated. The common code block f6 is an example of the superclass “User”. The superclass “User” is an abstract class that abstracts the common processing extracted from the classes f5a and f5b. Specifically, the superclass is a class in which four common methods of the classes f5a and f5b are implemented.

The output message 463 is text data added by the LLM during the plurality of partial code blocks are generated. Each of the partial code blocks f6a and f6b is a subclass that excludes four common methods and inherits the superclass “User” from each of the classes f5a and f5b. Therefore, in the example of FIG. 12, it can be said that the common code block is a class of an object-oriented program, and each of the plurality of partial code blocks is generated as a subclass that inherits the common code block.

In this way, in Example 3 of the use case, five classes selected by the engineer are set as refactoring targets, a pair of two classes are grouped as abstraction targets by the LLM, and a superclass and two subclasses are generated for the pair of two grouped classes. Therefore, the abstraction can be efficiently and accurately generated for the source code of the object-oriented programming language using the LLM. The same effects as those of the second example are obtained.

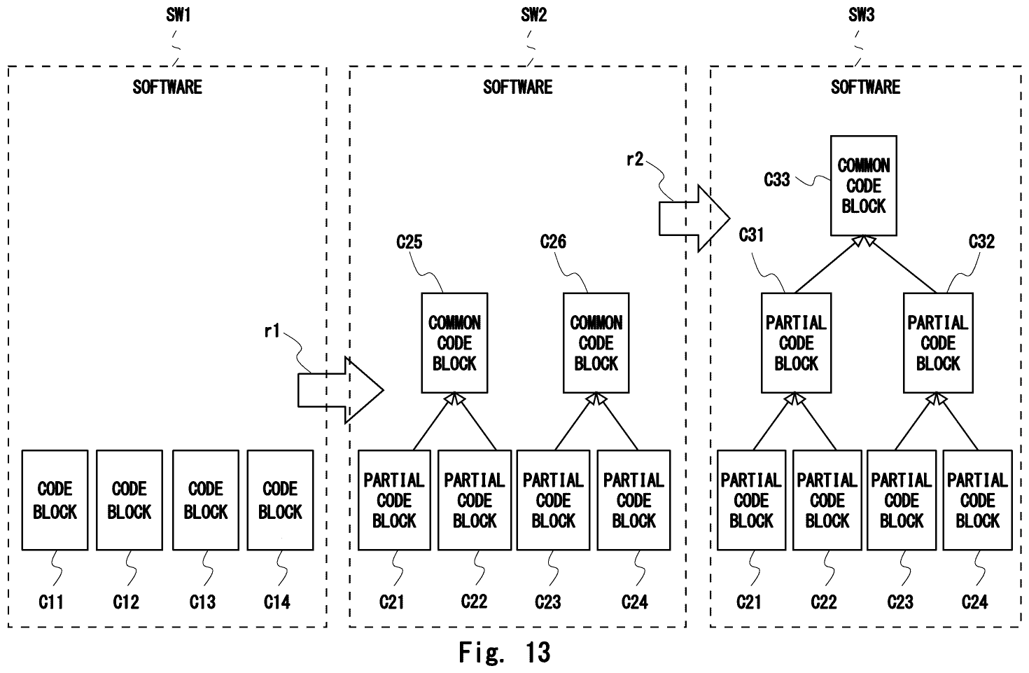

FIG. 13 is a diagram illustrating a concept of a refactoring support method. In the refactoring support method according to the present disclosure, first, target software SW1 includes code blocks C11 to C14. Then, the software SW1 is subjected to refactoring r1 to be reconfigured to the software SW2. Specifically, in the refactoring r1, the LLM abstracts code blocks C11 and C12 to generate a common code block C25 (superclass) and generates partial code blocks C21 and C22 as subclasses that inherit the common code block C25 from the code blocks C11 and C12. Similarly, the LLM generates a common code block C26 and partial code blocks C23 and C24 from the code blocks C13 and C14. Further, in refactoring r2, the LLM abstracts the common code blocks C25 and C26 to generate a common code block C33 (superclass) and generates partial code blocks C31 and C32 as subclasses that inherit the common code block C33 from the common code blocks C25 and C26.

Here, development of a refactoring-dedicated program in which an algorithm for refactoring is implemented (hard-coded) is costly, and customization is often required according to characteristics of each programming language. The refactoring-dedicated program is required to support a change in specifications of a programming language.

On the other hand, in the refactoring support system 1000 according to the present disclosure, by applying the LLM to refactoring of large-scale software, it is possible to obtain information regarding refactoring candidates with high accuracy easily as compared with a case where a refactoring-dedicated program is used. Therefore, the software engineer can easily obtain an output result of the information processing apparatus 100 and perform fine correction, degradation confirmation, and the like. In the case of application to refactoring of the legacy code, it is possible to support organization of the source code. Therefore, it is possible to achieve efficiency of work that requires a large number of man-hours manually.

Accordingly, the LLM can be used to support software refactoring. Additionally, in the example embodiment, various effects similar to those of the above-described first example embodiment can be obtained.

### Third Example Embodiment

In a third example embodiment, a case where application to a language model is performed in two stages of processing for grouping at least a part of a set of a plurality of programs into a plurality of code blocks including a similar description and processing for generating a common code block and a plurality of partial code blocks from the plurality of code blocks belonging to a group will be described.

That is, the information processing apparatus 100 includes a first input unit, a first acquisition unit, a second input unit, and a second acquisition unit. The first input unit inputs a first input text including the first instruction sentence and at least the part of the set of the plurality of programs to a predetermined language model. The first instruction sentence is a sentence for extracting a group of a plurality of code blocks including a similar description determined to have high similarity in feature information of a program by the language model from at least a part of the set of the plurality of programs included in predetermined software.

The first acquisition unit acquires a group of the plurality of code blocks extracted based on the first instruction sentence by the language model.

The second input unit inputs a second input text including a second instruction sentence and a plurality of code blocks to the language model. The second instruction sentence is a sentence for generating, from the plurality of code blocks belonging to the group, a common code block in which the common processing based on the similar description is described and a plurality of partial code blocks corresponding to each code block based on a difference between each code block and the similar description.

The second acquisition unit acquires the common code block and the plurality of partial code blocks generated from the plurality of code blocks based on the second instruction sentence by the language model.

The other configurations according to the third example embodiment are the same as those of the above-described second example embodiment, and thus repeated description and illustration thereof will be omitted as appropriate. Hereinafter, differences from the second example embodiment will be mainly described.

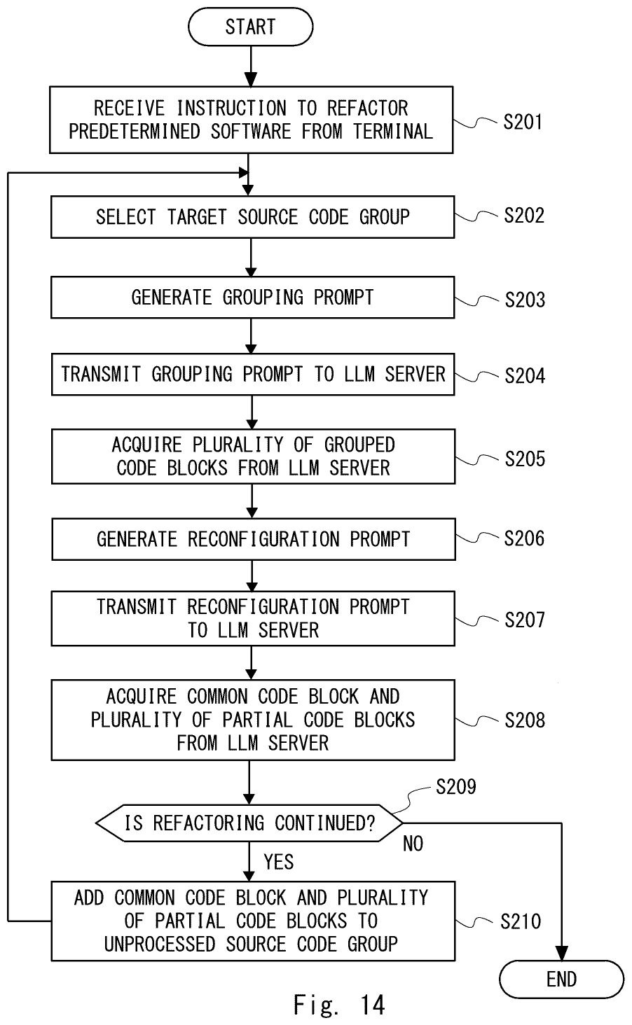

FIG. 14 is a flowchart illustrating a flow of a refactoring support method. First, the reception unit 121 receives an instruction to refactor the target software from the terminal (S201). Subsequently, the selection unit 1221 selects a target source code group from the target software 111 (S202).

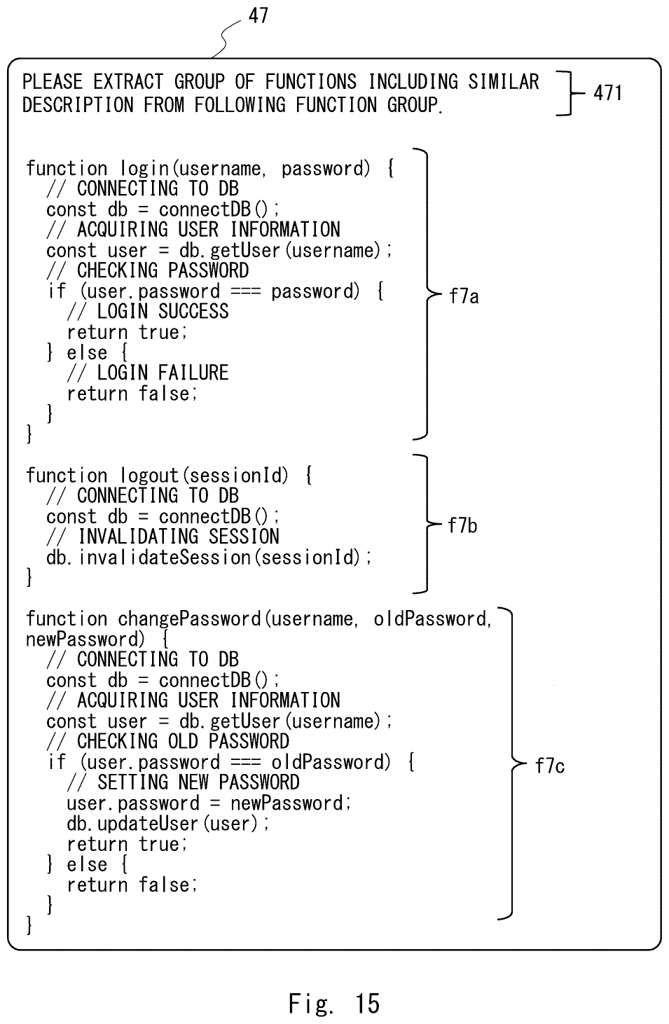

Subsequently, the generation unit 1222 generates a grouping prompt from the selected target source code group (S203). The grouping prompt is an example of the above-described first input text. FIG. 15 is a diagram illustrating an example of a grouping prompt 47 input to the LLM. The grouping prompt 47 is an example of text data (first input text) including an instruction sentence 471 and the target source code group (functions f7a, f7b and f7c). The instruction sentence 471 is a sentence for extracting a group of functions including the similar description from the functions f7a, f7b, and f7c. The functions f7a, f7b, and f7c are similar to the functions f3a, f3b, and f3c in FIG. 9.

Subsequently, the input unit 1223 transmits the grouping prompt 47 to the LLM server 200 (S204). Accordingly, the LLM server 200 inputs the received grouping prompt 47 to the LLM. The LLM extracts the group of the functions including the similar description from the three functions in accordance with the instruction sentence 471 included in the grouping prompt 47. Here, similarly to Example 2 of the second example embodiment described above, the LLM extracts the functions f7a and f7c from the three functions as a group of functions. The LLM server 200 transmits an output message including the plurality of grouped code blocks grouped by the LLM to the information processing apparatus 100 via the network N.

Accordingly, the acquisition unit 1224 acquires an output message including the plurality of grouped code blocks from the LLM server 200 (S205). Then, the output unit 123 displays the output message on the developer terminal 300. Specifically, the output unit 123 transmits the acquired output message to the developer terminal 300 via the network N. Then, the developer terminal 300 displays the received output message on the screen.

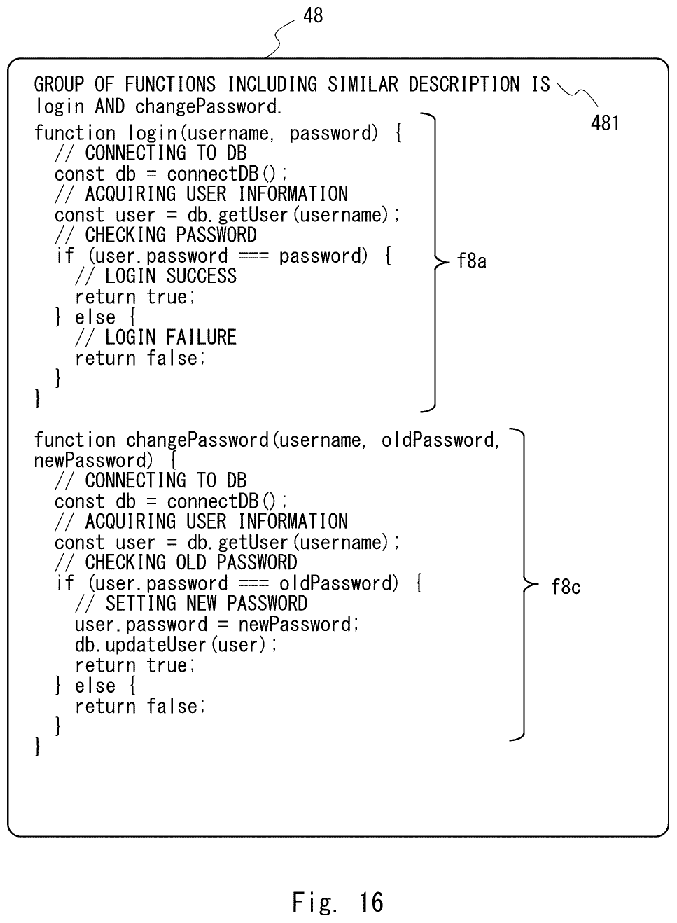

FIG. 16 is a diagram illustrating an example of an output result (group of functions) from the LLM. Output data 48 is an example of an output message 481 and the functions f8a and f8c displayed on the screen of the terminal 300. The output message 481 is text data added by the LLM during the group of the functions including the similar description is extracted. This example indicates that the functions f8a “login” and f8c “changePassword” are extracted as a group.

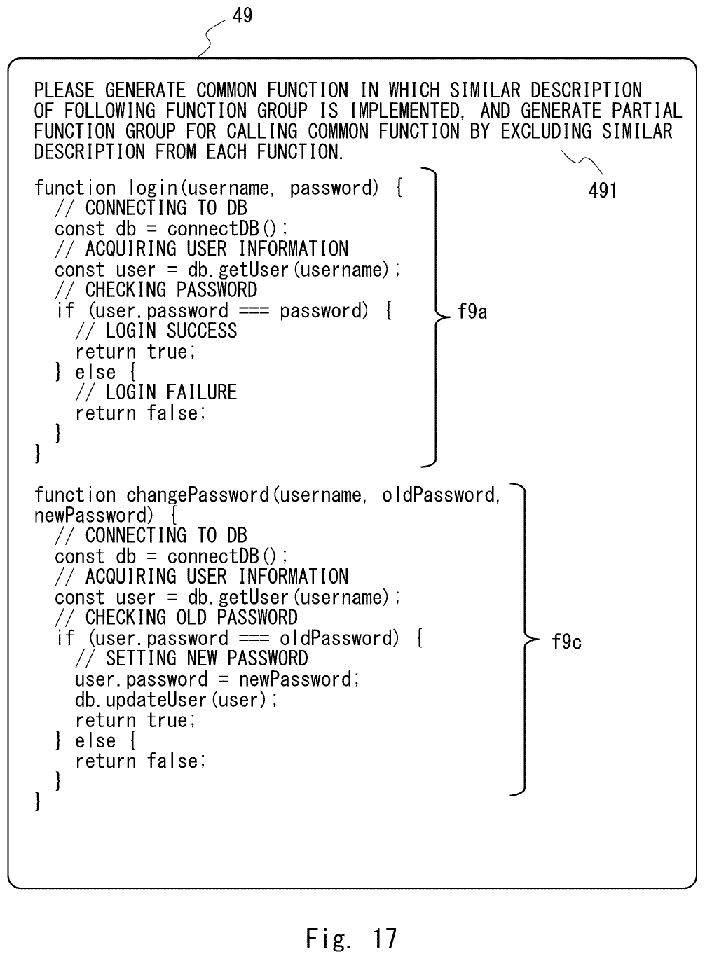

Subsequently, the generation unit 1222 generates a reconfiguration prompt from the plurality of grouped code blocks (S206). The reconfiguration prompt is an example of the above-described second input text. FIG. 17 is a diagram illustrating an example of the reconfiguration prompt 49 input to the LLM. The reconfiguration prompt 49 is an example of text data (second input text) including the instruction sentence 491 and the functions f9a and f9c. The instruction sentence 491 is a sentence for generating the common function in which the similar description of the functions f9a and f9c belonging to the extracted group is implemented, and generating a partial function group for calling the common function by excluding the similar description from each function. Note that the functions f9a and f9c are similar to the above-described functions f8a and f8c in FIG. 16.

Subsequently, the input unit 1223 transmits the reconfiguration prompt 49 to the LLM server 200 (S207). Accordingly, the LLM server 200 inputs the received reconfiguration prompt 49 to the LLM. The LLM extracts the common processing (the DB connection processing and the user information acquisition processing) based on the similar processing from the functions f9a and f9c belonging to the extracted group in accordance with the instruction sentence 491 included in the reconfiguration prompt 49 and generates a common function “connectAndGetUser” in which the common processing is described. Then, the LLM removes the similar description from each function of the extracted group in accordance with the instruction sentence 491 to generate a subfunction group for calling the common function. The LLM server 200 transmits an output message including the common code block and the plurality of partial code blocks generated by LLM to the information processing apparatus 100 via the network N.

Accordingly, the acquisition unit 1224 acquires an output message including the common code block and the plurality of partial code blocks from the LLM server 200 (S205). Then, the output unit 123 displays the output message on the developer terminal 300. Specifically, the output unit 123 transmits the acquired output message to the developer terminal 300 via the network N. Then, the developer terminal 300 displays the received output message on the screen.

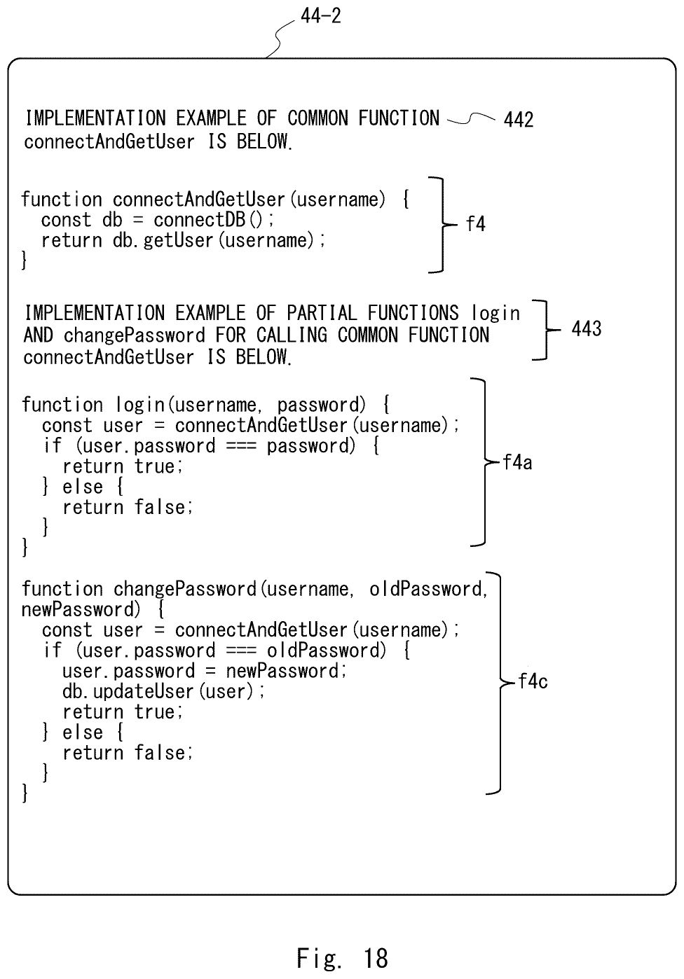

FIG. 18 is a diagram illustrating an example of output results (the common function and the partial function group) from the LLM. Output data 44-2 is an example of the output message 442, the common code block f4, the output message 443, and the partial code blocks f4a and f4c displayed on the screen of the terminal 300. The data has similar configurations denoted by the same reference numerals in FIG. 10.

As described above, in the third example embodiment, application to a language model is performed in two stages of the processing for grouping at least a part of the set of the plurality of programs into the plurality of code blocks including the similar description and the processing for generating the common code block and the plurality of partial code blocks from the plurality of code blocks belonging to the group. Therefore, it is possible to effectively utilize the function of the LLM while avoiding restriction of the input information amount to the language model. Additionally, in the example embodiment, various effects similar to those of the above-described first example embodiment can be obtained.

The language model used in the third example embodiment may not be the same at each stage. The technique according to the present disclosure may use, for example, a first language model that groups at least a part of a set of a plurality of programs into a plurality of code blocks including a similar description, and a second language model that generates a common code block and a plurality of partial code blocks from a plurality of code blocks belonging to a group. In this case, the first language model may be a trained model that inputs at least a part of a set of a plurality of programs and outputs a group of a plurality of code blocks including the similar description. The second language model may be a trained model that inputs a plurality of code blocks belonging to a group and outputs the generated common code block and a plurality of partial code blocks. In this case, an instruction sentence in each input text to each language model can be omitted. Some of the first and second language models may be common.

### Other Example Embodiments

The above-described information processing apparatus may contain a language model such as an LLM.

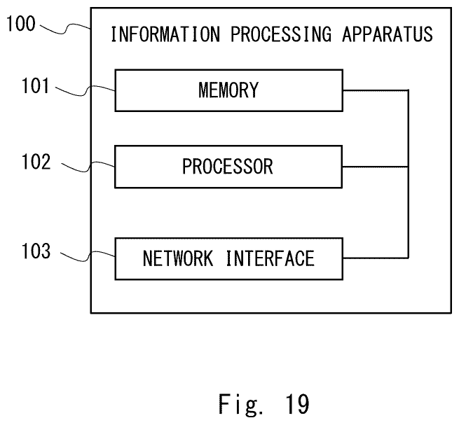

FIG. 19 is a block diagram illustrating a hardware configuration of the above-described information processing apparatus 100 and the like. The information processing apparatus 100 includes a memory 101, a processor 102, and a network interface 103.

The memory 101 is configured by a combination of a volatile memory and a nonvolatile memory. The volatile memory is, for example, a volatile storage device such as a random access memory (RAM) and is a storage region where information is temporarily held during operation of the processor 102. The nonvolatile memory is, for example, a nonvolatile storage device such as a hard disk or a flash memory. The memory 101 stores at least a computer program in which processing of the information processing method (refactoring support method) in the information processing apparatus 100 according to the present disclosure is implemented. The memory 101 may include a storage disposed away from the processor 102. In this case, the processor 102 may access the memory 101 via an input/output (I/O) interface (not illustrated).

The processor 102 is a control device that controls each configuration of the information processing apparatus 100. The processor 102 reads and executes software (computer program) from the memory 101. Accordingly, the processor 102 realizes functions of the reception unit 121, the execution control unit 122 (the selection unit 1221, the generation unit 1222, the input unit 1223, and the acquisition unit 1224), and the output unit 123. That is, the processor 102 performs processing of an information processing method in the information processing apparatus 100 according to the present disclosure. The processor 102 may be, for example, a microprocessor, a multi processing unit (MPU), or a CPU. The processor 102 may include a plurality of processors.

The network interface 103 may be used to communicate with network nodes. The network interface 103 may include, for example, a network interface card (NIC) conforming to IEEE 802.3 series. IEEE represents Institute of Electrical and Electronics Engineers. The network interface 103 may include a wireless local area network (LAN), a wired LAN, Wi-Fi (registered trademark), Bluetooth (registered trademark), and the like.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note A1)

An information processing apparatus comprising:
at least one memory storing instructions; and
at least one processor configured to execute the instructions to;
extract, using a predetermined language model, a group of a plurality of code blocks including a similar description determined to have high similarity of feature information of a program by the language model from at least a part of a set of a plurality of programs included in predetermined software and
generate, from the plurality of code blocks belonging to the group, using the language model, a common code block in which common processing based on the similar description is described and a plurality of partial code blocks corresponding to each code block based on a difference between each code block and the similar description.

### (Supplementary Note A2)

The information processing apparatus according to Supplementary Note A1, wherein the at least one processor is further configured to execute the instructions to generate the common code block and the plurality of partial code blocks using the language model so that each of the plurality of partial code blocks has a function equivalent to each corresponding code block using the common code block.

### (Supplementary Note A3)

The information processing apparatus according to Supplementary Note A1 or A2, wherein the group is a pair of code blocks including the similar description.

### (Supplementary Note A4)

The information processing apparatus according to any one of Supplementary Note A1 to A3, wherein the feature information includes a logical structure of a program.

### (Supplementary Note A5)

The information processing apparatus according to any one of Supplementary Note A1 to A4, wherein the at least one processor is further configured to execute the instructions to set the common code block and the plurality of partial code blocks generated by the language model as targets together with a program other than the group in the set of the plurality of programs, and repeatedly executes extraction of the group and generation of the common code block and the plurality of partial code blocks using the language model.

### (Supplementary Note A6)

The information processing apparatus according to any one of Supplementary Note A1 to A5, wherein
the common code block is a function of a program, and
each of the plurality of partial code blocks is generated including a process of calling the common code block.

### (Supplementary Note A7)

The information processing apparatus according to any one of
Supplementary Note A1 to A5, wherein the common code block is a class of an object-oriented program, and
each of the plurality of partial code blocks is generated as a subclass that inherits the common code block.

### (Supplementary Note A8)

The information processing apparatus according to any one of Supplementary Note A1 to A7, wherein the at least one processor is further configured to execute the instructions to;
input, to the language model, a first input text including a first instruction sentence for extracting a group of a plurality of code blocks including the similar description from at least a part of the set of the plurality of programs and generating, from the plurality of code blocks belonging to the group, a common code block in which common processing based on the similar description is described and a plurality of partial code blocks corresponding to each code block based on a difference between each code block and the similar description, the first input text including at least a part of the set of the plurality of programs, and
acquire the common code block and the plurality of partial code blocks generated from the plurality of code blocks based on the first instruction sentence by the language model.

### (Supplementary Note A9)

The information processing apparatus according to any one of Supplementary Note A1 to A7, wherein the at least one processor is further configured to execute the instructions to;
input, to the language model, a second input text including a second instruction sentence for extracting a group of the plurality of code blocks including the similar description from at least a part of the set of the plurality of programs, and at least a part of the set of the plurality of programs,
acquire the group of the plurality of code blocks extracted based on the second instruction sentence by the language model,
input, to the language model, a third input text including a third instruction sentence for generating, from the plurality of code blocks belonging to the group, a common code block in which common processing based on the similar description is described and a plurality of partial code blocks corresponding to each code block based on a difference between each code block and the similar description, the third input text including the plurality of code blocks, and
acquire the common code block and the plurality of partial code blocks generated from the plurality of code blocks based on the third instruction sentence by the language model.

### (Supplementary Note B1)

An information processing method causing a computer to execute:
extracting, using a predetermined language model, a group of a plurality of code blocks including a similar description determined to have high similarity of feature information of a program by the language model from at least a part of a set of a plurality of programs included in predetermined software;
generating, from the plurality of code blocks belonging to the group, using the language model, a common code block in which common processing based on the similar description is described and a plurality of partial code blocks corresponding to each code block based on a difference between each code block and the similar description; and
acquiring the common code block and the plurality of partial code blocks generated from the plurality of code blocks by the language model.

### (Supplementary Note C1)

A non-transitory computer-readable medium storing an information processing program causing a computer to execute:
a process of extracting, using a predetermined language model, a group of a plurality of code blocks including a similar description determined to have high similarity of feature information of a program by the language model from at least a part of a set of a plurality of programs included in predetermined software, and generating, from the plurality of code blocks belonging to the group, a common code block in which common processing based on the similar description is described and a plurality of partial code blocks corresponding to each code block based on a difference between each code block and the similar description; and
a process of acquiring the common code block and the plurality of partial code blocks generated from the plurality of code blocks by the language model.

### (Supplementary Note D1)

An information processing apparatus comprising:
at least one memory storing instructions; and
at least one processor configured to execute the instructions to;
input, to the language model, an input text including an instruction sentence for extracting a similar description determined to have high similarity of feature information of a program by a predetermined language model from a plurality of code blocks included in a set of a plurality of programs included in predetermined software, and generating a common code block in which common processing based on the similar description is described and a plurality of partial code blocks corresponding to each code block based on a difference between each code block and the similar description, the input text including the plurality of code blocks; and
acquire the common code block and the plurality of partial code blocks generated from the plurality of code blocks based on the instruction sentence by the language model.

### (Supplementary Note E1)

An information processing apparatus comprising:
at least one memory storing instructions; and
at least one processor configured to execute the instructions to;
input a first input text including a first instruction sentence for extracting a group of a plurality of code blocks including a similar description determined to have high similarity of feature information of a program by a predetermined language model from at least a part of a set of a plurality of programs included in predetermined software and at least a part of the set of the plurality of programs to the language model;
acquire a group of the plurality of code blocks extracted based on the first instruction sentence by the language model;
input, to the language model, a second input text including a second instruction sentence for generating, from the plurality of code blocks belonging to the group, a common code block in which common processing based on the similar description is described and a plurality of partial code blocks corresponding to each code block based on a difference between each code block and the similar description, the second input text including the plurality of code blocks; and
acquire the common code block and the plurality of partial code blocks generated from the plurality of code blocks based on the second instruction sentence by the language model.

Some or all of the elements (for example, configurations and functions) described in supplementary notes A2 to A9 dependent on supplementary note A1 {e.g. apparatus} can also be dependent on supplementary note B1 {e.g. method} and supplementary note C1 {e.g. program} by the same dependency relationship as supplementary notes A2 to A9. Some or all of the elements (for example, configurations and functions) described in supplementary notes A2 to A7 dependent on supplementary note A1 {e.g. apparatus} can also be dependent on supplementary note D1 {e.g. apparatus} and supplementary note E1 {e.g. apparatus} by the same dependency relationship as supplementary notes A2 to A7. Some or all of the elements described in any supplementary note may be applied to various types of hardware, software, recording means for recording software, systems, and methods.

What is claimed is:

1. An information processing apparatus comprising:
at least one memory storing instructions; and
at least one processor configured to execute the instructions to;
extract, using a predetermined language model, a group of a plurality of code blocks including a similar description determined to have high similarity of feature information of a program by the language model from at least a part of a set of a plurality of programs included in predetermined software and
generate, from the plurality of code blocks belonging to the group, using the language model, a common code block in which common processing based on the similar description is described and a plurality of partial code blocks corresponding to each code block based on a difference between each code block and the similar description.

2. The information processing apparatus according to claim 1, wherein the at least one processor is further configured to execute the instructions to generate the common code block and the plurality of partial code blocks using the language model so that each of the plurality of partial code blocks has a function equivalent to each corresponding code block using the common code block.

3. The information processing apparatus according to claim 1, wherein the group is a pair of code blocks including the similar description.

4. The information processing apparatus according to claim 1, wherein the feature information includes a logical structure of a program.

5. The information processing apparatus according to claim 1, wherein the at least one processor is further configured to execute the instructions to set the common code block and the plurality of partial code blocks generated by the language model as targets together with a program other than the group in the set of the plurality of programs, and repeatedly executes extraction of the group and generation of the common code block and the plurality of partial code blocks using the language model.

6. The information processing apparatus according to claim 1, wherein
the common code block is a function of a program, and
each of the plurality of partial code blocks is generated including a process of calling the common code block.

7. The information processing apparatus according to claim 1, wherein
the common code block is a class of an object-oriented program, and
each of the plurality of partial code blocks is generated as a subclass that inherits the common code block.

8. The information processing apparatus according to claim 1, wherein the at least one processor is further configured to execute the instructions to;
input, to the language model, a first input text including a first instruction sentence for extracting a group of a plurality of code blocks including the similar description from at least a part of the set of the plurality of programs and generating, from the plurality of code blocks belonging to the group, a common code block in which common processing based on the similar description is described and a plurality of partial code blocks corresponding to each code block based on a difference between each code block and the similar description, the first input text including at least a part of the set of the plurality of programs, and
acquire the common code block and the plurality of partial code blocks generated from the plurality of code blocks based on the first instruction sentence by the language model.

9. The information processing apparatus according to claim 1, wherein the at least one processor is further configured to execute the instructions to;
input, to the language model, a second input text including a second instruction sentence for extracting a group of the plurality of code blocks including the similar description from at least a part of the set of the plurality of programs, and at least a part of the set of the plurality of programs,
acquire the group of the plurality of code blocks extracted based on the second instruction sentence by the language model,
input, to the language model, a third input text including a third instruction sentence for generating, from the plurality of code blocks belonging to the group, a common code block in which common processing based on the similar description is described and a plurality of partial code blocks corresponding to each code block based on a difference between each code block and the similar description, the third input text including the plurality of code blocks, and
acquire the common code block and the plurality of partial code blocks generated from the plurality of code blocks based on the third instruction sentence by the language model.

10. An information processing method causing a computer to execute:
extracting, using a predetermined language model, a group of a plurality of code blocks including a similar description determined to have high similarity of feature information of a program by the language model from at least a part of a set of a plurality of programs included in predetermined software;
generating, from the plurality of code blocks belonging to the group, using the language model, a common code block in which common processing based on the similar description is described and a plurality of partial code blocks corresponding to each code block based on a difference between each code block and the similar description; and
acquiring the common code block and the plurality of partial code blocks generated from the plurality of code blocks by the language model.

11. An information processing apparatus comprising:
at least one memory storing instructions; and
at least one processor configured to execute the instructions to;
input, to the language model, an input text including an instruction sentence for extracting a similar description determined to have high similarity of feature information of a program by a predetermined language model from a plurality of code blocks included in a set of a plurality of programs included in predetermined software, and generating a common code block in which common processing based on the similar description is described and a plurality of partial code blocks corresponding to each code block based on a difference between each code block and the similar description, the input text including the plurality of code blocks; and
acquire the common code block and the plurality of partial code blocks generated from the plurality of code blocks based on the instruction sentence by the language model.
